(19) United States
(12) Patent Application Publication
(10) Pub. No.: US 2026/0265485 A1
(43) Pub. Date: Sep. 10, 2026

(54) SYSTEMS UTILIZING RECYCLED CARBON DIOXIDE

(71) Applicant: Titan America LLC, Norfolk, VA (US)

(72) Inventors: Cesar David Verdugo, Deerfield Beach, FL (US); Joseph Matthew Clark, Jr., Boynton Beach, FL (US); Erika Faye Fischer, Boynton Beach, FL (US); Jeffrey Albert Getz, St Johns, FL (US); Tiffany Elisha Walker, Gates, NC (US)

(73) Assignee: Titan America LLC, Norfolk, VA (US)

(21) Appl. No.: 19/465,808

(22) Filed: Jan. 30, 2026

Related U.S. Application Data
(60) Provisional application No. 63/760,158, filed on Feb. 19, 2025.

(51) Int. Cl. C08K 3/24; B01D 53/00; B29B 9/06; B29K 105/26; C08J 5/00

(52) U.S. Cl. CPC C08K 3/24; B29B 9/06; C08J 5/00; B01D 53/00; B01D 2257/504; B01D 2258/0233; B29K 2105/26

(57) ABSTRACT

The present disclosure includes a method of capturing CO₂ gas from a cement manufacturing plant and purifying the CO₂ gas to provide recycled CO₂ gas, pelletizing recycled polymeric material, converting the captured CO₂ gas to supercritical CO₂ gas, contacting the supercritical CO₂ gas with the recycled polymeric material in an extruder to provide a CO₂-laden polymeric material; plasticizing and extruding the CO₂-laden polymeric material; forming pellets of the plasticized and extruded CO₂-laden polymeric material; and injecting the pellets into a mold to form a plastic article of manufacture.

### RELATED APPLICATION

The present application claims priority to U.S. Provisional No. 63/760,158 filed Feb. 19, 2025, the disclosures of which are incorporated herein by reference in their entireties.

### FIELD

The present disclosure relates to capturing carbon dioxide (CO₂) from, for example, the production of concrete, and using the captured/recycled CO₂ to produce plastic articles of manufacture from recycled materials including recycled polymer materials and glass.

### BACKGROUND

CO₂ is generated by a wide variety of industrial processes. CO₂ is regarded as a major contributor to global warming. The emission of CO₂ into the atmosphere is much greater than the natural processes for removing CO₂ resulting in atmospheric CO₂ amounts increasing. It is believed by many that this is supercharging the greenhouse effect to increase temperatures around the world. Thus, CO₂ emissions is a global issue.

The use of fossil fuels is often cited as the major contributor to CO₂ generation, thus a majority of the world's attention is directed to reducing CO₂ emission based on use of fossil fuels. An additional contributor to CO₂ emission, however, is the construction industry. In the making of concrete, particularly the cement portion, CO₂ is a by-product in the conversion of a component of the cement portion, clinker, in which limestone (calcium carbonate) is converted to lime (CaO) as part of its production. Thus, capturing the CO₂ and recycling would reduce the concrete industry's carbon footprint based on CO₂ emissions. The CO₂ emissions from transport of concrete should also be included and thus, the concrete industry is looking for better ways to reduce its carbon footprint. Finally, by utilizing recycled materials as a sustainable alternative to virgin raw materials in combination with the captured/recycled CO₂ the amount of waste plastic and glass in landfills may be reduced and offers a use for the recycled CO₂.

For example, the concrete industry also utilizes a large amount of natural aggregates in the production of concrete. Concrete is typically a mixture of cement, natural aggregate (fine and coarse) and water. The natural aggregate is typically a mixture of gravel, sand, and crushed rock. The procurement of natural aggregates involves mines and quarries, and results in a rather large carbon footprint because of the number of vehicles needed to collect the natural aggregate. Aggregate materials are needed to make concrete mixes more compact and contribute to the mechanical strength in rigid concrete structures. The natural aggregates, however, contribute to the overall weight of concrete. The use of plastic aggregates to reduce weight and reduce the environmental effects of mining and transporting heavy aggregates has been suggested.

Thus, efforts need to be made to reduce the overall carbon footprint associated with concrete production.

### SUMMARY

The present disclosure provides a system to use both recycled CO₂ and recycled plastic or glass material to make various articles of manufacture. One article of manufacture is synthetic aggregate which may be used to replace or lower the amount of natural aggregates. Another article of manufacture is recycled glass articles having CO₂ sequestered therein.

The present disclosure includes a method of capturing CO₂ gas from a cement manufacturing plant and purifying the CO₂ gas to provide recycled CO₂ gas, pelletizing recycled polymeric material, converting the captured CO₂ gas to supercritical CO₂ gas, contacting the supercritical CO₂ gas with the recycled polymeric material in an extruder to provide a CO₂-laden polymeric material; plasticizing and extruding the CO₂-laden polymeric material; forming pellets of the plasticized and extruded CO₂-laden polymeric material; and injecting the pellets into a mold to form a plastic article of manufacture.

In another embodiment, recycled glass is crushed and the captured CO₂ gas converted to supercritical CO₂ gas is contacted with the recycled glass in an extruder to provide a CO₂-laden glass material. The CO₂-laden glass material may be extruded to provide a foamed glass material. The foamed glass material may then be crushed to produce aggregate-size particles which may be used in forming a concrete article of manufacture.

In another embodiment, a closed system for manufacturing various articles of manufacture based on concrete including CO₂-encapsulated synthetic aggregate is provided. The system may include a CO₂ purifying station for purifying CO₂ gas captured from a cement manufacturing process, a first pelletizer for pelletizing recycled polymeric material, a conversion tank for converting captured CO₂ gas to supercritical CO₂ gas, an injector for supplying supercritical CO₂ gas from the conversion tank, an extruder connected with the injector and the pelletizer wherein when the pellets of recycled polymeric material are provided In the extruder, the pellets are melted and the melted pellets are injected with a supercritical CO₂ to provide a polymeric material having CO₂ encapsulated therein, a second pelletizer for pelletizing the polymeric material having CO₂ encapsulated therein into a synthetic aggregate, and a mold for forming a concrete-based article such as the aggregate having CO₂ encapsulated therein. Alternatively recycled glass may be utilized in which a CO₂-laden foam glass material is provided, crushed, and then formed into a concrete-based article.

### DESCRIPTION OF THE DRAWINGS

Having thus described the presently disclosed subject matter in general terms, reference will now be made to the accompanying drawings, which are not necessarily drawn to scale, and wherein:

FIG. 1 is a schematic representation of a method and a closed system of the present disclosure for providing an article of manufacture from recycled polymeric material.

FIG. 2 is a schematic representation of a method and a closed system of the present disclosure for providing an article of manufacture from recycled glass.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

Although the present approach has been described herein with referenced to certain embodiments of the present invention, it is to be understood that the invention defined by the appended claims is not to be limited by details set forth in the above description as may perform similar functions and/or achieve like results. All such equivalent embodiments and examples are within the spirit and scope of the present approach.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise”, “comprises”, “comprising”, “include”, “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions ad methods of the present invention, means that the compositions/methods may contain additional components so long as the additional components do not materially alter the composition/method. The term “materially alter”, as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

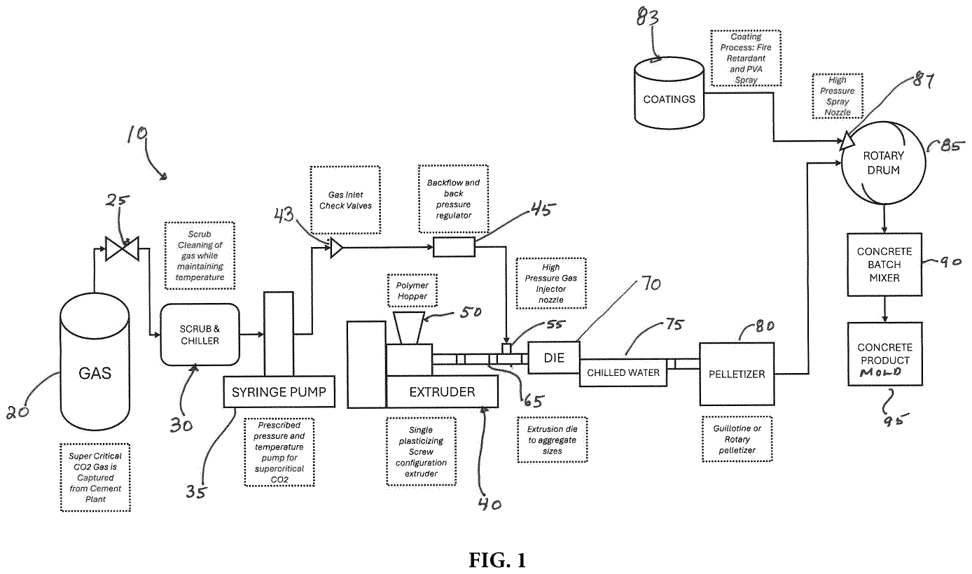

Referring to FIG. 1, a schematic of the system for performing the method of the disclosure is shown generally at 10. Carbon dioxide (CO₂) may be captured from the process for manufacturing clinker for concrete and collected in a tank 20 from a single or multiple concrete plants. Concrete in general comprises cement, water and aggregate with various other additives. One of the components of cement is clinker. Clinker is produced by heating limestone (calcium carbonate) with other materials like clay and shale. During the heating/calcination process, calcium carbonate is broken down into calcium oxide (clinker) and CO₂. The CO₂, historically was released into the atmosphere which should be avoided.

The captured CO₂ may be purified and converted to supercritical CO₂ in supply tank 20. Supercritical CO₂ is in a fluid state and is held in the tank 20 above its critical temperature 30.9780° C. and critical pressure 73.773 barr. It is transported via a valve 25 to a scrubber/chiller 30. The chiller 30 in combination with a syringe pump 35 may be utilized to control the flow and pressure of the supercritical CO₂ from supply tank 20 to an extruder 40 via a gas inlet check valve 43. The extruder may be any suitable extruder, the selection of which is within the skill of one in the art. A backflow valve 45 may be included to prevent backflow of the supercritical CO₂.

The extruder 40 may include a hopper 50 for receiving recycled polymeric material. Exemplary polymers to be recycled may include low density polyethylene, high density polyethylene, polypropylene, polyethylene terephthalate, and polyvinylchloride, and blends thereof. In one embodiment, the recycled polymeric material is high density polyethylene from plastic bottle caps, milk jugs and laundry detergent bottles. In another embodiment, the recycled polymeric material may be a blend of high density polyethylene and polypropylene from shampoo bottles and clamshell packaging, for example. In yet another embodiment, the recycled polymeric material may be polypropylene from single serve cups such as yogurt cups or from take-out containers.

The extruder 40 includes a barrel 65 with a screw (not shown). The barrel 65 receives the polymeric material from the hopper 50 and delivers the material to the barrel so that the recycled polymeric material may be plasticized within the barrel 65. An injector 55 feeds the supercritical CO₂ through an injection port into the extruder 40. The supercritical CO₂ may be contacted with the plasticized recycled polymeric material to provide a CO₂-laden polymeric material. The CO₂-laden polymeric materials may then be transported via to an extrusion die 70 and may be extruded into a water bath 75. From the water bath, the plasticized and extruded CO₂-laden polymeric material may be pelletized in a pelletizer 80. A guillotine or rotary pelletizer may be used. In one embodiment, the CO₂ may be encapsulated in the recycled polymeric material. In another embodiment the pellets may be in the shape of synthetic aggregate to be used in forming concrete articles of manufacture.

The pellets of CO₂-laden polymer material may be contacted and treated with various additives such as flame retardants stored in coatings tank 83 and injected via injector 87 into a rotary drum 85. In one embodiment, the treated pellets may be transported to a concrete batch mixer 90 and then formed into a concrete-based article of manufacture in a concrete molding apparatus 95. Exemplary articles include ready mix concrete, precast concrete articles such as concrete masonry units, concrete for three-dimension printing such as described in U.S. application Ser. No. 18/104,379 A1, and non-structural concrete applications. In one embodiment, the articles are treated with a flame retardant so that the concrete article passes various International Building Codes (IBC) for concrete articles such as the codes for two-hour flame resistance.

In another embodiment, the pellets may be molded such as by injection molding into an article of manufacture with the CO₂ encapsulated in the article. Exemplary articles may include pallets, packaging material, toys, automotive parts (e.g., interior panels, sound insulation and non-structural trim), building materials (e.g., insulating materials, cladding and formwork materials), three-dimensional printing filaments, and sport equipment.

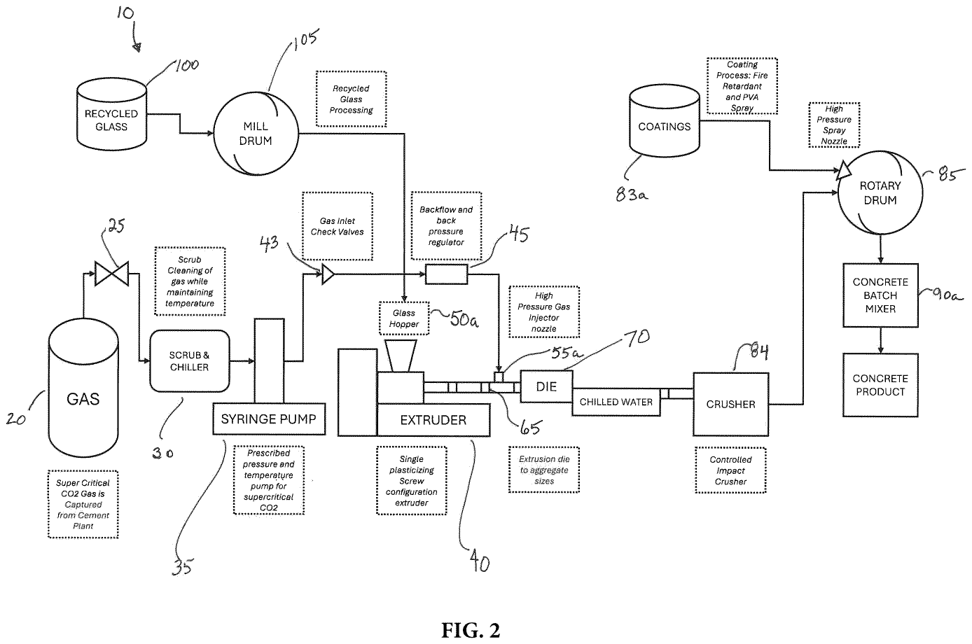

Referring to FIG. 2, in another embodiment, recycled glass material may be contacted with the supercritical CO₂ to provide a foamed glass material. Recycled glass 100 may pass through a mill drum 105 to reduce the size of the recycled glass 100. The recycled glass material is fed into hopper 50a. The extruder barrel 65 receives the recycled glass material from the hopper 50a, and the glass material is heated within the barrel for a sufficient residence time to soften or melt the glass material. An injector 55a feeds the supercritical CO₂ through an injection port 60a and transferred to the extruder 40a. Glass with encapsulated CO₂ may then be formed. The recycled CO₂ glass may then be transported via an extrusion die 70 and cooled using a water bath 75a. From the water bath 75a, the glass material article may be broken up with a crusher 84 such as a controlled impact crusher. The crushed glass material with encapsulated CO₂ may then be treated with various additives in a coatings tank 83a and injected into a rotary drum 85a. The crushed glass material may then be transported to the concrete molding apparatus 90a. Exemplary articles include lightweight concrete products, non-structural precast elements, insulating concrete, masonry units, aggregate materials, and geotechnical fill materials.

Many modifications and other embodiments of the invention set forth herein will come to mind to one skilled in the art to which this invention pertains having the benefit of the teachings presented in the descriptions here. Therefore, it is to be understood that the invention is not to be limited to the specific embodiments disclosed and that modifications and other embodiments are intended to be included within the scope of the appended claims.

That which is claimed is:

1. A method for forming a plastic article of manufacture using recycled CO₂ and recycled polymeric material, the method comprising the steps of:
capturing CO₂ gas from a cement manufacturing plant and purifying the CO₂ gas to provide recycled CO₂ gas;
pelletizing recycled polymeric material;
converting the captured CO₂ gas to supercritical CO₂ gas;
contacting the supercritical CO₂ gas with the recycled polymeric material in an extruder to provide a CO₂-laden polymeric material;
plasticizing and extruding the CO₂-laden polymeric material;
forming pellets of the plasticized and extruded CO₂-laden polymeric material; and
injecting the pellets into a mold to form the plastic article of manufacture.

2. The method of claim 1, wherein the CO₂-laden polymeric material comprises CO₂ encapsulated in the polymeric material.

3. The method of claim 2, wherein the plastic article of manufacture is plastic aggregate for a concrete-based article of manufacture.

4. The method of claim 1, wherein the article of manufacture is an injection molded plastic article.

5. A closed system for manufacturing concrete-based articles of manufacture including CO₂-encapsulated plastic aggregate, the system comprising:
a CO₂ purifying station for purifying CO₂ gas captured from a cement manufacturing process;
a first pelletizer for pelletizing recycled polymer material;
a conversion tank for converting captured CO₂ gas to supercritical CO₂ gas;
an injector for supplying supercritical CO₂ gas from the conversion tank;
an extruder connected with the injector and the pelletizer wherein when the pellets of recycled glass material are provided in the extruder, the pellets are melted and the melted pellets are injected with a supercritical CO₂ to provide a glass material having CO₂ encapsulated therein;
a second pelletizer for pelletizing polymeric material having CO₂ encapsulated therein into an aggregate, and
a mold for forming concrete-based articles of manufacture having the aggregate with polymeric material with CO₂ encapsulated therein.

6. A method for forming an article of manufacture using recycled CO₂ and recycled glass material, the method comprising the steps of:
capturing CO₂ gas from a cement manufacturing plant and purifying the CO₂ gas to provide recycled CO₂ gas;
providing recycled glass material;
converting the captured CO₂ gas to supercritical CO₂ gas;
contacting the supercritical CO₂ gas with the recycled glass material in an extruder to provide a glass material having CO₂ entrapped therein;
extruding the glass material having CO₂ entrapped therein; and,
forming pellets of the extruded glass material having CO₂ entrapped therein.

7. A closed system for manufacturing concrete-based articles of manufacture including CO₂-encapsulated glass aggregate, the system comprising:
a CO₂ purifying station for purifying CO₂ gas captured from a cement manufacturing process;
a mill drum for reducing the size of the recycled glass material
a conversion tank for converting captured CO₂ gas to supercritical CO₂ gas;
an injector for supplying supercritical CO₂ gas from the conversion tank;
an extruder connected with the injector and the pelletizer wherein when the recycled glass is provided in the extruder, the glass is melted and the melted glass is injected with a supercritical CO₂ to provide a glass material having CO₂ encapsulated therein;
a second pelletizer for pelletizing the glass material having CO₂ encapsulated therein into an aggregate, and
a mold for forming concrete-based articles of manufacture having the aggregate with polymeric material with CO₂ encapsulated therein.
